(19) United States
(12) Patent Application Publication
(10) Pub. No.: US 2011/0136442 A1
(43) Pub. Date: Jun. 9, 2011

(54) APPARATUS AND METHODS FOR IDENTIFYING A USER OF AN ENTERTAINMENT DEVICE VIA A MOBILE COMMUNICATION DEVICE

(75) Inventor: William Michael Beals, Englewood, CO (US)

(73) Assignee: ECHOSTAR TECHNOLOGIES LLC, Englewood, CO (US)

(21) Appl. No.: 12/633,988

(22) Filed: Dec. 9, 2009

(51) Int. Cl. H04B 1/38

(52) U.S. Cl. 455/73

(57) ABSTRACT

Described herein are systems, methods and apparatus for identifying a user of an entertainment device. An entertainment device includes a wireless transceiver that communicatively couples to a mobile communication device through a wireless network The wireless transceiver and the mobile communication device automatically establish a communication link over the wireless network when the mobile communication device is located proximate the entertainment device. The entertainment device further comprises control logic operable to identify a user of the mobile communication device, responsive to establishment of the communication link, based on information identifying the mobile communication device and customize output of content responsive to identifying the user.

### BACKGROUND

Entertainment devices, such as cable or satellite television receivers include many features which may be personalized based on a particular user of the device. For example, favorite lists, movie recommendations, advertising, restricted content and the like may be customized depending on a particular user of the entertainment device. A particular entertainment device may have multiple users that may be using the device at any particular time and thus, the device may identify the user before personalizing the content experience for the user. However, techniques, such as each user logging into the entertainment device with a username/pas sword, are cumbersome for many users who are used to just picking up a television remote control and changing the channel using a simple numeric keypad. Thus, it would be desirable for an entertainment device to identify a user in a more convenient manner in order to simplify the viewing experience for the user.

### BRIEF DESCRIPTION OF THE DRAWINGS

The same number represents the same element or same type of element in all drawings.

FIG. 1 illustrates an embodiment of an entertainment system.

FIG. 2 illustrates an embodiment of the entertainment device of FIG. 1.

FIG. 3 illustrates another embodiment of an entertainment system.

FIG. 4 illustrates an embodiment of an entertainment system incorporating a directional antenna in an entertainment device.

FIG. 5 illustrates an embodiment of a process for operating an entertainment device.

### DETAILED DESCRIPTION

The various embodiments described herein generally provide apparatus, systems and methods which facilitate the identification of a user of an entertainment device. More particularly, an entertainment device is configured to communicate with a mobile communication device positioned proximate the entertainment device. Based on the communication with the mobile communication device, the entertainment device identifies a user of the mobile communication device and customizes the entertainment experience available through the entertainment device for that user. In short, described herein are apparatus, systems and methods for identifying a user of an entertainment device via an associated mobile communication device.

The entertainment device will be described herein in the context of a television receiver, e.g., a terrestrial, cable, satellite or internet protocol television (IPTV) receiver. However, it is to be appreciated that the techniques described herein may be applied to any type of device operable to output content for presentation to a user, including audio content, video content, audio/video content, data and the like. Other exemplary entertainment devices include audio playback devices (e.g., CD players, MP3 players, audio jukeboxes and the like), optical audio/video playback devices (e.g., DVD players, Blu-Ray players or the like), audio/video servers and audio/video set-top boxes.

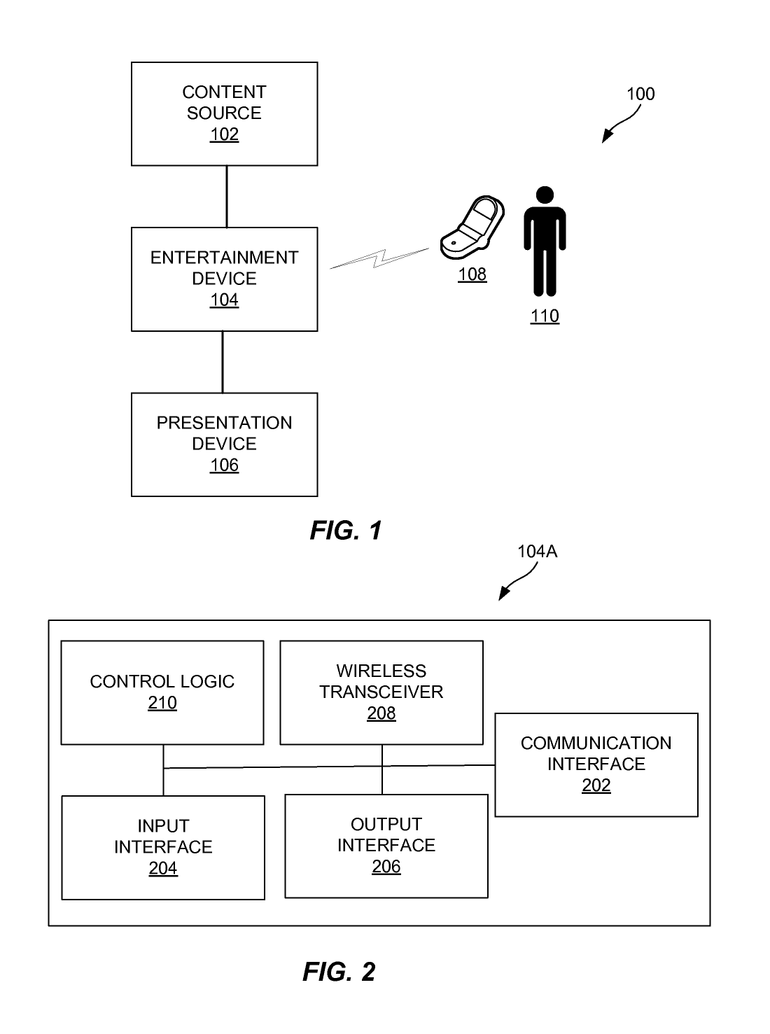

FIG. 1 illustrates an embodiment of an entertainment system 100. The entertainment system 100 presents content to a user 110. The entertainment system 100 includes a content source 102, an entertainment device 104, a presentation device 106 and a mobile communication device 108. Each of these components is discussed in greater detail below. The entertainment system 100 may include other devices, components or elements not illustrated for the sake of brevity.

The content source 102 is operable for providing content to the entertainment device 104 for output. In at least one embodiment, the content source 102 is operable to receive and/or generate content for communication via a communication system to one or more entertainment devices 104. The content to be received, processed, outputted and/or communicated may come in any of various forms including, but not limited to, audio, video, data, information, or otherwise. Exemplary content sources 102 include over-the-air (OTA) terrestrial transmission facilities, cable television distribution head-ends, satellite television uplink centers, broadband or internet servers and the like. In other embodiments, the content source 102 may comprise a server that provides audio/video content to the entertainment device 104 over a communication network, such as a local area network (LAN) or wide area network (WAN). In at least one embodiment, the content source 102 may comprise a storage medium that the entertainment device 104 accesses to retrieve and playback content therefrom. Exemplary storage mediums include internal or external hard drives, optical storage disks, magnetic storage disks, removable storage drives and the like.

The entertainment device 104 is operable to receive content from one or more content sources 102 and to output the received content for presentation to the user 110 via the presentation device 106. In at least one embodiment, the presentation device 106 is a display device (e.g., a television) configured to display content to the user 110. In other embodiments, the presentation device 106 is an audio playback device (e.g., audio receivers, speaker(s) or the like). The entertainment device 104 may receive content in any format (e.g., analog or digital format) and output the audio, video, audio/video stream or data for presentation by the presentation device 106. The entertainment device 104 may be further configured to display menus and other information that allow a user 110 to control the output of content by the entertainment device 104. In at least one embodiment, the entertainment device 104 is a set-top box (e.g., a satellite, cable or IPTV receiver, digital video recorder (DVR) or other similar device) that processes and provides one or more audio, video or audio/video output streams to the presentation device 106 for presentation to the user 110. In some embodiments, the entertainment device 104 and the presentation device 106 may be integrated as a device combining the functionality of a display device and a set-top box, DVR or the like.

The mobile communication device 108 may comprise any type of non-stationary communication device utilized by the user 110. For example, the mobile communication device 108 may comprise a wireless or mobile telephone, personal digital assistant (PDA), netbook, tablet PC or the like. In at least one embodiment, the mobile communication device 108 is operable to communicatively couple to the entertainment device 104 over an appropriate wireless communication link. For example, the mobile communication device 108 may be communicatively coupled over a short range WPAN. In at least one embodiment, the WPAN is formed over a Bluetooth communication link. Other communication technologies that may be utilized to operate a WPAN communication link include infrared data association (IrDA), ultra wide-band (UWB), Z-Wave and IEEE 15.4-2003 (also known as ZigBee). It is to be appreciated that any type of WPAN technology may be utilized in accordance with the teachings described herein.

In at least one embodiment, the mobile communication device 108 and the entertainment device 104 communicatively couple over a communication link when in close proximity with one another. For example, the mobile communication device 108 and the entertainment device 104 may be paired such that a WPAN communication link is automatically created when the mobile communication device 108 is within wireless range of the entertainment device 104. If the mobile communication device 108 is within wireless range of the entertainment device 104, then it is possible that the user 110 is in the same room as the entertainment device 104, and thus, experiencing content via the entertainment device 104. Therefore, the entertainment device 104 is operable to identify the user 110 of the mobile communication device 108 as presently using the entertainment device 104 when the communication link between the mobile communication device 108 and the entertainment device 104 is active. Responsive to identifying the user 112, the entertainment device 104 is operable to customize the entertainment experience for the user 110.

For example, the entertainment device 104 may control access to content, select particular content for presentation, customize the layout of the interface, customize personal favorite lists, content recommendations, settings and the like responsive to identifying the user 110. In at least one embodiment, one or more users of the entertainment device 104 may have profiles specifying various preferences, content restrictions, content lists and the like. Each profile may be associated with a particular mobile communication device 108. When the mobile communication device 108 is in communication with the entertainment device 104, the entertainment device 104 may load a corresponding user profile and customize the content experience for the user 110 based on the user profile.

FIG. 2 illustrates an embodiment of the entertainment device of FIG. 1. More particularly, FIG. 2 illustrates the entertainment device embodied as a television receiver 104A. The television receiver 104A includes a communication interface 202, an input interface 204, an output interface 206, a wireless transceiver 208 and control logic 210. Each of these components is discussed in greater detail below. The television receiver 104A may include other elements, components or devices which are not illustrated for the sake of brevity. It is also to be appreciated that other entertainment devices utilizing the techniques described herein may include similar components as the television receiver 104A.

The communication interface 202 is operable to receive content from the content source 102 (see FIG. 1). In at least one embodiment, the communication interface 202 receives and tunes a television signal including television programming. The communication interface 202 may receive an over-the-air (OTA) broadcast, a direct broadcast satellite signal, a cable television signal or an IPTV signal and tune the content to extract the selected television programming. In at least one embodiment, the communication interface 202 may comprise multiple tuners, utilized by the television receiver 104A to output and/or record multiple television programs simultaneously.

The input interface 204 is operable to wirelessly receive data from a remote control (not shown in FIGS. 1 and 2). The data received from the remote control may be utilized by the control logic 210 to control the output of content by the control logic 210.

The output interface 206 is operable to interface with the presentation device 106 (see FIG. 1). More particularly, the output interface 206 is operable to output information for presentation by the presentation device 106. The output interface 206 may be operable to output any type of presentation data to the presentation device 106, including audio data, video data, audio/video (A/V) data, textual data, imagery or the like.

The wireless transceiver 208 is operable to bi-directionally communicate with the mobile communication device 108 (see FIG. 1). The wireless transceiver 208 may utilize any type of wireless protocol and/or wireless communication medium to communicate with the mobile communication device 108. In at least one embodiment, the wireless transceiver 208 comprises a Bluetooth transceiver that communicates with the mobile communication device 108 over a WPAN. For example, the wireless transceiver 208 and the mobile communication device 108 may be paired through an appropriate pairing process, as described in detail below, such that a communication link is established automatically when the mobile communication device 108 is within wireless range of the wireless transceiver 208.

The control logic 210 is operable for controlling the operation of the television receiver 104A. As used herein, control logic 210 refers to a single processing device or a group of inter-operational processing devices. In at least one embodiment, the operation of the control logic 210 may be controlled by instructions executable by the control logic 210. Some examples of instructions are software, program code, and firmware. Additionally, the operation of particular functionalities of the control logic 210 is controllable based on commands received from a remote control via the input interface 204.

In at least one embodiment, the control logic 210 is operable for receiving and processing presentation content, e.g., video content from the communication interface 202 and controlling the output of the content to the presentation device 106 via the output interface 206. The control logic 210 may also receive or retrieve content from a storage medium, such as an optical disk, internal or external hard drive, a portable storage device (e.g., universal serial bus (USB) memory sticks) and the like and control the output of the content to the presentation device 106. The control logic 210 may also receive content from external servers, such as video servers, that are communicatively coupled to the television receiver 104A over the internet or other types of data networks.

In at least one embodiment, the control logic 210 is operable to identify a user 110 of the mobile communication device 108. For example, the wireless transceiver 208 may automatically establish a communication link with the mobile communication device 108 when the mobile communication device 108 enters wireless range of the wireless transceiver 208. During establishment of the communication link, the wireless transceiver 208 exchanges various data with the mobile communication device 108. In at least one embodiment, some of the data includes information identifying the mobile communication device 108. For example, a device identifier, MAC address, network address or the like are examples of information identifying the mobile communication device 108. Based upon processing of the identifying information, the mobile entertainment device 108 identifies a user 110 of the mobile communication device 108.

In at least one embodiment, each user of the television receiver 104A may have a profile associated with one or more mobile communication devices 108. Thus, when the mobile communication device 108 connects to the wireless transceiver, the control logic 210 can identify the user 110 of the mobile communication device 108 as presently using the television receiver 104A and retrieve the corresponding profile for the user 110. The control logic 210 is then operable to customize the output of content to the presentation device 106 based upon the user's 110 profile information.

In at least one embodiment, the control logic 210 is operable to control access to particular content and features of the television receiver 104A responsive to identifying the user 110. For example, each user of the television receiver 104A may be associated with content access restrictions specifying television channels, stored content or external content that the user 110 may access through the television receiver 104A. If the user's 110 content access restrictions specify access to the content, then the control logic 210 may operate to output the content or otherwise allow the user 110 to browse and/or access the content.

In at least one embodiment, the identification of the user 110 may be utilized to select content for presentation to the user 110. For example, the control logic 210 may utilize the identification of the user to target advertising for output in association with other content. In at least one embodiment, the television receiver 104A may store a profile of the user 110 specifying any number of criteria regarding the user 110, such as age, gender, hobbies, interests, occupation, viewing habits and the like. The control logic 210 operates to select advertising, based on the profile information, and output the selected advertising in association with other content for viewing by the user 110.

In at least one embodiment, the control logic 210 may select and recommend content for viewing by the user 110 responsive to identifying the user 110. For example, a user 110 may often watch action movies and the control logic 210 may maintain viewing habits of the user 110 or a viewing history based on content that the user 110 has previously viewed. Based upon processing of the viewing habits or viewing history data, the control logic 210 may recommend other action movies which the user 110 may also be expected to enjoy.

In at least one embodiment, the control logic 210 may customize the interface outputted for presentation by the presentation device 106, such as the appearance of the user interface (e.g., menus), the language of the television receiver 104A or the associated content, settings and the like. The control logic 210 may also customize personalized content lists, such as favorite lists or lists of recorded content, based on an identified user 110. It is to be appreciated that the control logic 210 may customize the viewing experience for the user 110 in any manner responsive to identifying the user 110 using the identification techniques described herein.

As described above, the wireless transceiver 208 and the mobile communication device 108 may be paired such that a communication link is created automatically when the mobile communication device 108 is within wireless range of the wireless transceiver 208. For example, Bluetooth allows for two devices to be paired together during an installation/synchronization process. In at least one embodiment, the control logic 210 is operable to output one or more menu interfaces to solicit information from the user 110 for pairing the wireless transceiver 208 to the mobile communication device 108. The control logic 210 may be operable to establish settings that specify information for automatically establishing the communication link.

The pairing process allows two devices to communicate automatically during subsequent communication sessions without user intervention initiating the communication link each time. The mobile communication device 108 may be further associated with a user of the television receiver. Because the communication link is established automatically, a user 110 is logged into the television receiver 104A while in proximity to the television receiver 104A without taking any action to provide input to the television receiver 104A each time to login.

In at least one embodiment, the user 110 is logged off the television receiver 104A when their mobile communication device 108 leaves the vicinity of the television receiver 104A. For example, if the mobile communication device 108 leaves wireless range of the wireless transceiver 208, then the communication link may be disconnected. Responsive to identifying the disconnection of the communication link, the control logic 210 logs the user off the television receiver 104A. The output of content may then be modified accordingly responsive to disconnection of the communication link between the television receiver 104A and the mobile communication device 108. In at least one embodiment, the control logic 210 returns to a default state and thus, does not customize the viewing experience for any user. If multiple users are logged into the television receiver 104A and one user is disconnected, then the control logic 210 may operate to continue customizing the viewing experience based on the remaining users 110 logged into the television receiver 104A. For example, if a first user logs off the system, then the favorites lists and the like may be customized based on a second user still logged into the system.

In at least one embodiment, the wireless transceiver 208 and the mobile communication device 108 are operable to exchange caller identification information over the communication link. Thus, when the mobile communication device 108 receives a telephone call, the caller identification information may be transmitted to the wireless transceiver 208 and output by the control logic 210 for display by the presentation device 106. Thus, the user 110 may view the caller identification information on the presentation device 106 without utilizing the mobile communication device 108.

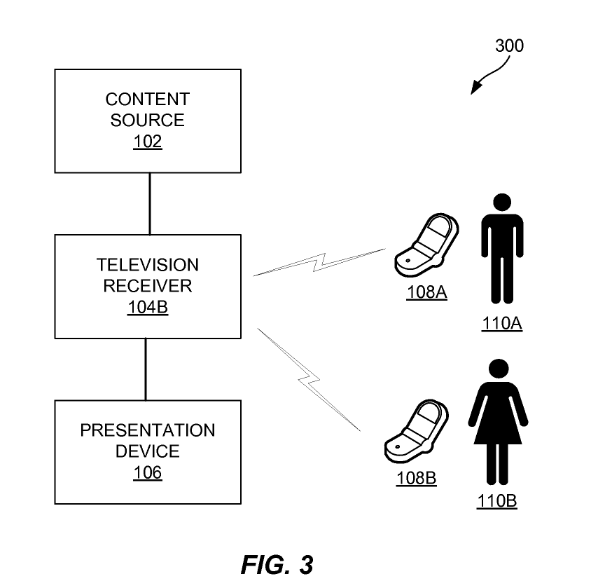

FIG. 3 illustrates an embodiment of an entertainment system 300. The entertainment system 300 presents content to one or more users 110A and 110B. The entertainment system 300 includes a content source 102, a television receiver 104B, a presentation device 106 and a plurality of mobile communication devices 108A and 108B. Each of these components is discussed in greater detail below. The entertainment system 300 may include other devices, components or elements not illustrated for the sake of brevity. The discussion of components common to FIGS. 1-2 is omitted herein for the sake of brevity.

The television receiver 104B is operable to output content for presentation by the presentation device 106 to the users 110A and 110B. The television receiver 104B includes wireless circuitry operable to communicate with multiple mobile communication devices 108A and 106B simultaneously. For example, multiple users 110A and 110B may be logged into the television receiver 104B. Further, users 110A and 110B may be automatically logged into the television receiver 104A and logged out as they walk away from the television receiver 104B and leave wireless range of the mobile communication device 108. While two users 110A and 110B are illustrated in FIG. 3, it is to be appreciated that the television receiver 104B may be configured to identify any number of users via any number of mobile communication devices and operate accordingly based on the identification of the users.

In at least one embodiment, the television receiver 104B operates to customize the viewing experience based on profiles of the multiple users 110A and 110B. For example, access to restricted content may be determined based on the information associated with both of the users 110A and 110B. Thus, the television receiver 104B may verify authorization to output television programming based on content access restrictions associated with both users 110A and 110B.

In at least one embodiment, access to content is determined based on content access restrictions of the user 110A or 110B having the greatest accessibility to content. In other words, if user 110A would not normally be allowed to view a program, but user 110B has authority to access to the program, then both users 110A and 110B may watch the program as long as user 110B remains in proximity to the television receiver 104B. In another embodiment, access to content is determined based on content access restrictions of the user 110A or 110B having the least accessibility to content. In other words, if user 110A would not normally be allowed to view a program, but the user 110B has access to the program, then neither users 110A and 110B may watch the program as long as user 110A remains in proximity to the television receiver 104B.

In at least one embodiment, the television receiver 104B may utilize the identification of multiple users 110A and 110B to collect demographic information regarding outputted television programming. For example, the television receiver 104B may collect data indicating that both a man and a woman watched a program if both users 110A and 110B are logged into the television receiver 104A. Thus, the demographic information collected by the television receiver 104B may be more granular based on the ability to identify users directly rather than just collecting data indicating that an unidentified user watched a particular program. Further, the control logic 210 may collect demographic information specifying what portions of a program a particular user 110A and 110B watched as each mobile communication device 108A and 108B leaves and/or returns within wireless range of the television receiver 104B during the duration of the program.

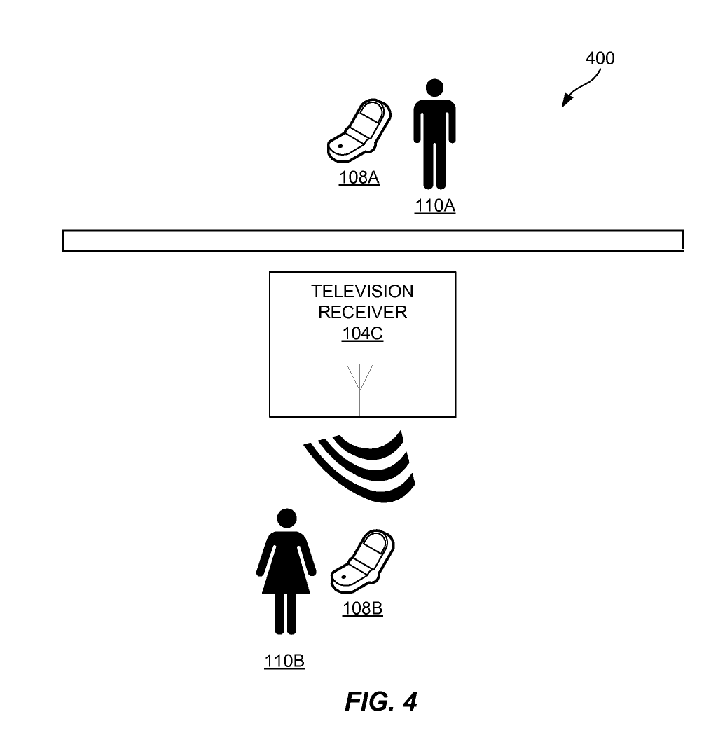

As described above, a television receiver configured in accordance with the teachings described herein identifies users that are within wireless range of an associated wireless transceiver. Normally, users within wireless range of a television receiver will be watching the programming being output by the television receiver. However, in at least one embodiment, a television receiver 104C (see FIG. 4) may be enhanced with a directional antenna 402 that is configured to communicate with a mobile communication device 108B of a user proximate the front of the television receiver 104C. In at least one embodiment, the directional antenna 402 comprises a uni-directional antenna. Because the antenna 402 emanates a signal in one or more selected directions, the television receiver 104C avoids communicating with the mobile communication device 108A in another room. Thus, the user 110A is not identified by the television receiver 104C when the user 110A is in another room and not likely watching the television program output by the television receiver 104C.

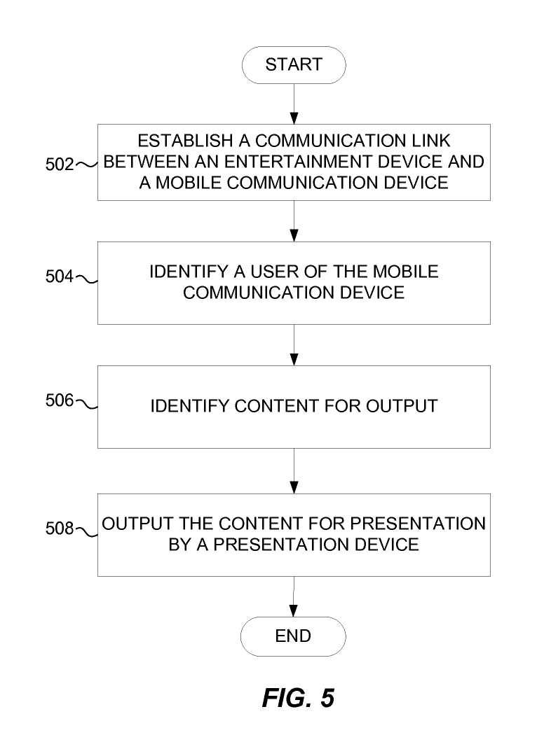

FIG. 5 illustrates an embodiment of a process for operating an entertainment device. The process of FIG. 5 is particularly directed at identifying a user of an entertainment device. The process of FIG. 5 may include other operations not illustrated for the sake of brevity.

The process includes establishing a communication link automatically between an entertainment device and a mobile communication device over a WPAN (operation 502). As described above, an entertainment device and a mobile communication device may be paired (e.g., through a Bluetooth pairing process) such that a communication link is created automatically when the devices are within wireless range of each other. Thus, when a user walks into a room, their mobile communication device will be within wireless range of the entertainment device and the two devices initiate a communication link therebetween.

The process further includes identifying a user of the mobile communication device based on information identifying the mobile communication device (operation 504). In at least one embodiment, responsive to establishment of the communication link between the entertainment device and the mobile communication device, the entertainment device logs the user into the entertainment device. The entertainment device may access settings associated with the identified user that specify operational characteristics for the entertainment device while the user is logged into the entertainment device.

The process further includes identifying content, in the entertainment device, for output to a presentation device, based on the user (operation 506). For example, the entertainment device may select content that a user is entitled to access, customize menu information, favorite lists, targeted advertising and the like based on the identification of the user. The process further includes outputting the content from the entertainment device to the presentation device (operation 508).

Although specific embodiments were described herein, the scope of the invention is not limited to those specific embodiments. The scope of the invention is defined by the following claims and any equivalents therein.

What is claimed is:

1. An entertainment device comprising:
a wireless transceiver that communicatively couples to a mobile communication device through a wireless personal area network, the wireless transceiver and the mobile communication device automatically establishing a communication link over the wireless personal area network when the mobile communication device is located proximate the entertainment device; and
control logic operable to:
identify a user of the mobile communication device, responsive to establishment of the communication link, based on information identifying the mobile communication device; and
customize output of content responsive to identifying the user.

2. The entertainment device of claim 1, further comprising:
an input interface that receives user input requesting to pair the mobile communication device and the wireless transceiver; and
the control logic operable to establish settings specifying information for automatically establishing the communication link.

3. The entertainment device of claim 1, wherein the control logic is operable to select content available for output based on the user.

4. The entertainment device of claim 1, wherein the control logic is operable to output a personalized content list associated with the user.

5. The entertainment device of claim 4, wherein the personalized content list comprises a list of favorite channels associated with the user.

6. The entertainment device of claim 4, wherein the personalized content list comprises a list of stored content associated with the user.

7. The entertainment device of claim 1, wherein the control logic is operable to collect viewing data, regarding the outputted content, based on the user.

8. The entertainment device of claim 1, wherein the control logic is operable to select advertising for output in association with the content based on the user.

9. The entertainment device of claim 1, wherein the wireless transceiver receives caller identification information from the mobile communication device and the control logic responsively outputs the caller identification information in association with the content.

10. The entertainment device of claim 1, further comprising:
a communication interface that receives television programming;
the control logic processing the television programming and selectively outputting a portion of the television programming for presentation by a presentation device based on the user.

11. The entertainment device of claim 1, wherein the wireless transceiver comprises a directional antenna orientated to communicate with the mobile communication device when the mobile communication device is positioned in front of an associated presentation device.

12. A method for operating an entertainment device, the method comprising:
establishing a communication link automatically between an entertainment device and a mobile communication device over a wireless personal area network;
identifying, in the entertainment device, a user of the mobile communication device, based on information identifying the mobile communication device, responsive to establishing the communication link;
identifying content, in the entertainment device, for output to a presentation device, based on the user; and
outputting the content from the entertainment device to the presentation device.

13. The method of claim 12, further comprising:
receiving user input, at the entertainment device, requesting to communicatively couple the mobile communication device and the entertainment device; and
establishing settings, on at least one of the mobile communication device and the entertainment device, the settings specifying information for automatically establishing the communication link.

14. The method of claim 12, further comprising:
identifying a disconnection of a communication link between the entertainment device and the mobile communication device; and
modifying the output of content from the entertainment device to the presentation device responsive to identifying the disconnection of the communication link.

15. The method of claim 12, wherein customizing the output of content further comprises:
selecting content available for output based on the user.

16. The method of claim 12, further comprising:
collecting viewing data, regarding the content, based on the user.

17. The method of claim 12, wherein customizing the output of content further comprises:
selecting an advertisement, for presentation in association with the content, based on the user; and
outputting the advertisement, in association with the content, for presentation by the presentation device.

18. A television receiver comprising:
a communication interface that receives television programming;
a wireless transceiver that establishes a first communication link with a first mobile communication device and establishes a second communication link with a second mobile communication device; and
control logic operable to:
identify a first user of the first mobile communication device responsive to establishment of the first communication link;
identify a second user of the second mobile communication device responsive to establishment of the second communication link;
verify authorization to output the television programming based on content access restrictions of at least one of the first user and the second user; and
output the television programming for presentation by a presentation device responsive to verifying the authorization to output the television programming.

19. The television receiver of claim 18, wherein the control logic is operable to collect demographic information for the television programming based on the first user and the second user.

20. The television receiver of claim 18, wherein the control logic is operable to:
identify a disconnection of the first communication link; and
control access to the television programming based on the content access restrictions of the second user.
